(19) United States
(12) Patent Application Publication
(10) Pub. No.: US 2007/0250297 A1
(43) Pub. Date: Oct. 25, 2007

(54) Method for reducing hazards

(75) Inventor: Janet A. Gill, Hollywood, MD (US)

Correspondence Address: NAVAL AIR WARFARE CENTER AIRCRAFT;DIVISION OFFICE OF COUNSEL BLDG 435, SUITE A, 47076 LILJENCRANTZ ROAD UNIT 7, PATUXENT RIVER, MD, 20670, US

(73) Assignee: The United States of America as represented by the Secretary of the Navy

(21) Appl. No.: 11/220,189

(22) Filed: Sep. 1, 2005

(51) Int. Cl. G06G 7/48

(52) U.S. Cl. 703/6

(57) ABSTRACT

A method for reducing hazards in a system under development, the method including: determining a hazard; determining causal factors of the hazard; determining mitigating requirements of the hazard; linking the causal factors to the mitigating requirement; and choosing an optimal mitigating requirement.

### STATEMENT OF GOVERNMENT INTEREST

The invention described herein may be manufactured and used by or for the Government of the United States of America for governmental purposes without payment of any royalties thereon or therefor.

### BACKGROUND

The present invention relates to a method for reducing hazards. More specifically, but without limitation, the present invention relates to a method that aids in the design and safety risk analysis of military and other critical systems.

Thus, there is a need in the art to provide an information system without the limitations inherent in present methods.

### SUMMARY

It is a feature of the invention to provide a method for reducing hazards that includes determining a hazard, determining causal factors of the hazard, linking the causal factors to mitigating requirements, and choosing an optimal mitigating requirement.

It is a feature of the invention to provide a method for reducing hazards that aids in the design and safety risk analysis of military and other critical systems, with the objective of increasing their safety critical and mission critical success.

It is a feature of the invention to provide a process for linking hazard causal factors to the optimal safety-critical mitigating requirement.

It is a feature of the invention to provide a methodology of providing evidence that a system is as safe as reasonably practical.

### BRIEF DESCRIPTION OF THE DRAWINGS

These and other features, aspects and advantages of the present invention will become better understood with reference to the following description and appended claims, and accompanying drawings wherein:

FIG. 1 is a flow chart depicting an embodiment of the method for reducing hazards;

FIG. 2 is a chart describing an embodiment of the method for reducing hazards;

FIG. 3 is a Hazard Risk Index for Naval aircraft;

FIG. 4 is a segment of a tree diagram of a system level root hazard;

FIG. 5 is a figure that exemplifies that Navigational Position System (NPS) and Global Positioning System (GPS) information is used in the mission computer algorithm that displays the position of the air vehicle, thus there are potential causal factors of each of the interoperable components and must be analyzed as an integrated subset of the overall system;

FIG. 6 is a diagram that depicts causes to the algorithm level for areas designated as safety-critical;

FIG. 7 is a diagram that depicts the linkage of the causal factors to the model of the system;

FIG. 8 is a table that is an example of a worksheet form that may be used to track generic SSR implementation; and

FIG. 9 is a Software Hazard Critically Matrix.

### DETAILED DESCRIPTION

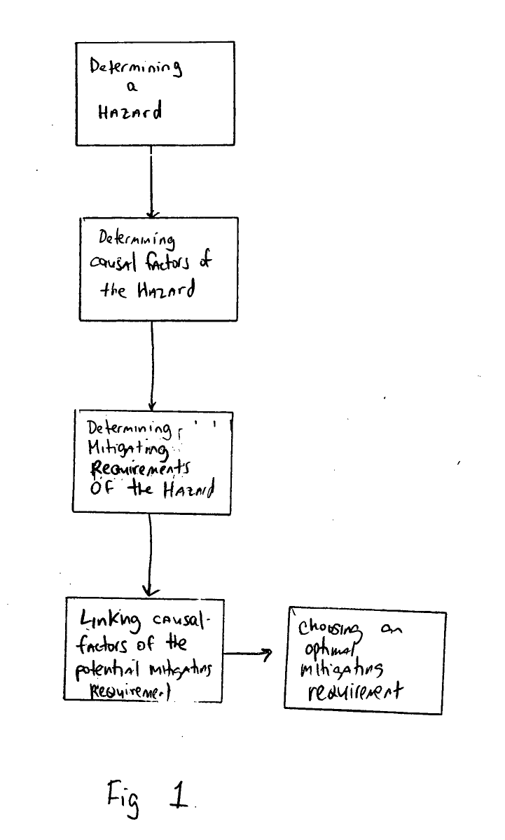

The preferred embodiment of the present invention is illustrated by way of example below and in FIGS. 1-9. As seen in FIG. 1, the method for reducing hazards includes determining a hazard, determining causal factors of the hazard, linking those causal factors to mitigating requirements, and choosing an optimal mitigating requirement.

The basis of sound design for a safety-critical system is the identification, through systematic analysis, of the hazards, which the system might encounter in operation. These hazards are identified in the context of the operation of the overall system in its operating environment.

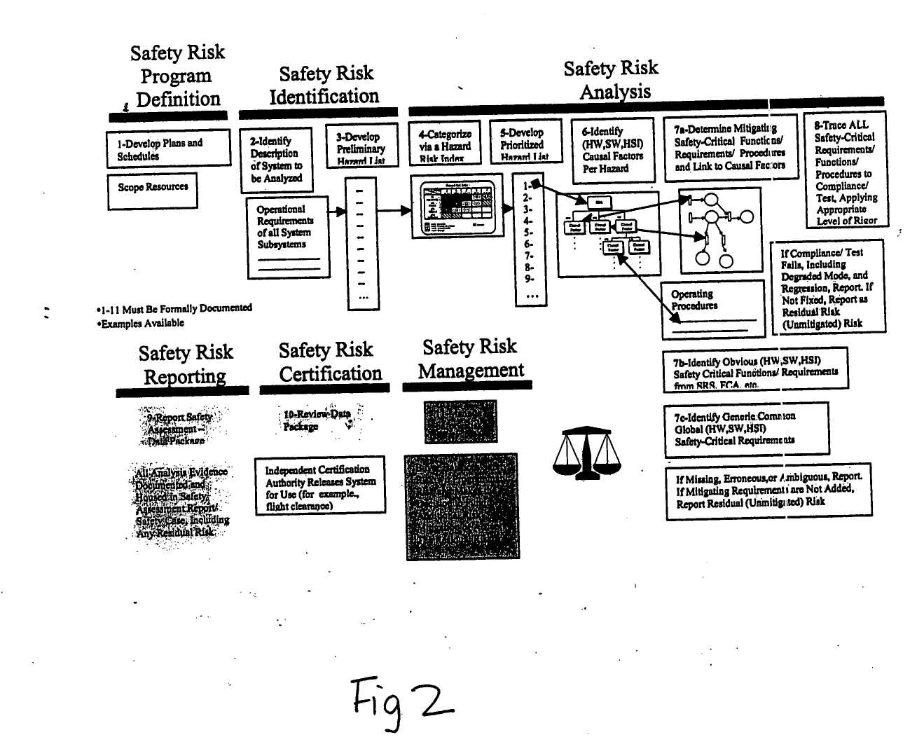

As seen in FIG. 2, the preferred embodiment of the method for reducing hazards includes the steps of safety risk program definition, safety risk identification, safety risk analysis, safety risk reporting, safety risk certification and safety risk management.

The first task in the method for reducing hazards is to determine the system or subsystem to be analyzed. Plans, schedule plans, schedules, and resources need to be identified and determined (shown as Steps 1 and 2 in FIG. 2). The Preliminary Hazard List (“PHL”) is then developed (Step 3 in FIG. 2).

The PHL is the initial set of hazards associated with the system- under development. Development of the PHL requires knowledge of the physical and functional requirements of the system and some foreknowledge of the conceptual system design. The documentation of the PHL helps to initiate the analyses that must be performed on the system, subsystems, and their interfaces. The PHL is based upon the review of analyses of similar systems, lessons learned, potential kinetic energies associated with the design, design handbooks, and user and systems specifications. The generated list also aids in the development of initial (or preliminary) requirements for the system designers and the identification of programmatic (technical or managerial) risks to the program.

The source of information that assists a user in compiling a preliminary list is: similar system hazard analysis; lessons learned; trade study results; preliminary requirements and specifications; design requirements from design handbooks (i.e., AFSC, DH1-6, System Safety); generic safety-critical analysis; and common sense.

The list of preliminary hazards of the proposed system becomes the basis of the Preliminary Hazard Analysis (PHA) and the consideration and development of design alternatives. The PHL must be used as inputs to proposed design alternatives and trade studies. As the design matures, the list is reviewed to eliminate those hazards that are not applicable for the proposed system, and to document and categorize those hazards deemed to contain inherent (potential) safety risk.

The list is then refined to reduce the list to true potential hazards. Some list items do not apply to the particular item being analyzed and are eliminated. Some list items are actually hazard causal factors and are saved for later analysis.

Specific ties to the software are normally through hazard causal factors, which have yet to be defined at this point in the development. However, there may be identified hazards which have preliminary ties to safety-critical functions, which in turn, are functionally linked to the preliminary software design architecture. If this is the case, this functional link should be adequately documented in the safety analysis for further development and analysis. At the same time there are likely to be specific “common global” safety critical requirements applicable to the system. These can be analyzed in parallel with the Hazard Analysis.

The PHA is a safety engineering and software safety engineering analysis performed to identify and prioritize hazards and their initial casual factors in the system under development.

Throughout this analysis, the PHA provides input to trade-off studies. These analyses offer alternative considerations for performance, reproducibility, testability, survivability, compatibility, supportability, reliability, and system safety during each phase of the development life cycle. System safety inputs to trade studies include the identification of potential or real safety concerns, and the recommendations of credible alternatives that may meet all (or most) of the requirements while reducing overall safety risk. The PHL is categorized and prioritized.

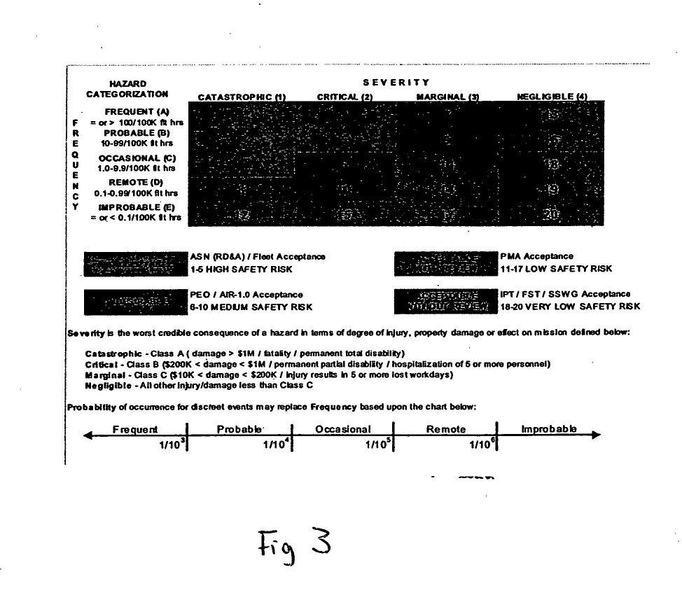

The entire unabridged list of potential hazards developed in the PHL is the entry point of PHA, Step 4, “Categorize via a Hazard Risk Index” of FIG. 2. The list should be reviewed for applicability and reasonability as the system design progresses. Any hazard not applicable to the system being analyzed should be eliminated from the PHL [e.g., if the system uses a titanium penetrator vice a Depleted Uranium (DU) penetrator, eliminate the DU related hazards]. The next task is to categorize and prioritize the remaining hazards according to a predetermined (System) Hazard Risk Index (HRI). FIG. 3 shows a Hazard Risk Index for Naval aircraft. The categorization provides an initial assessment of system hazard severity and probability of occurrence and, thus, the risk. The probability assessment at this point is usually subjective and qualitative. Step 5, “Develop a Prioritized Hazard List,” of FIG. 2, should then easily be initially created.

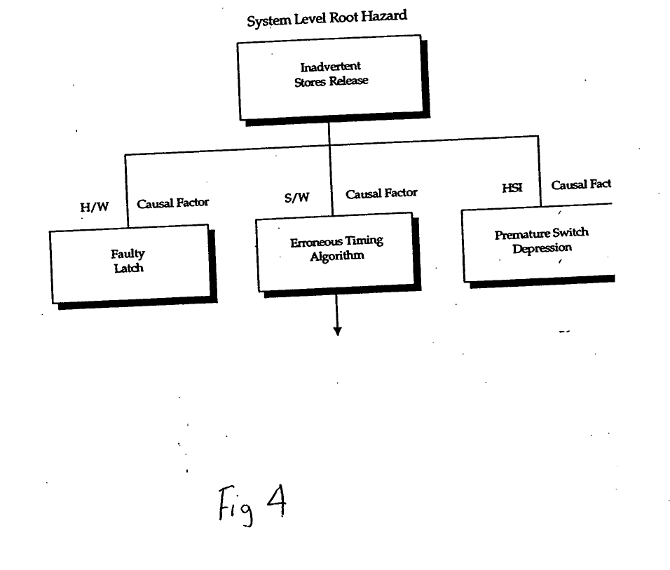

After the prioritized list of preliminary hazards is determined, Step 6, “Identify hardware (HW), software (SW), and human factor (HF) Causal Factors Per Hazard” of FIG. 2 can begin. The analysis proceeds with determining the hardware, software, and human interface causal factors to the individual hazard. For example, the prioritized potential hazard, “Inadvertent Stores Release” is shown in FIG. 4. As the hardware, software, and human system integration causal factors are determined, the fault tree, event tree, or other graphical representation gets fleshed out.

Analysis should be integrated and having all of the disciplines look at the fault tree from their own perspective ensures greater coverage in determining the set of causal factors that need to link with their mitigating safety-critical requirements. They each look through their “discipline prism” and can identify any holes in the specification. Software can cause hardware and human system integration causal factors, hardware can cause software and human system integration causal factors, and human system integration can cause software and hardware causal factors. The environment should always also be a consideration. The analyst must consider all paths to ensure coverage of the software safety analysis.

Although the tree diagram shown in FIG. 4 can represent the entire system, software safety is particularly concerned with the software causal factors linked to individual hazards in addition to ensuring that the mitigation of each causal factor is traced from requirements to design and code and subsequently tested. These preliminary analyses and subsequent system and software safety analyses identify when software is a potential cause, or contributor to a hazard, or will be used to support the control of a hazard.

The initial attempt to identify system-specific safety-critical requirements (SCRS) evolves from the PHA performed in the early phase of the development program. As previously discussed, the PHL/UPHA hazards are a product of the information reviewed pertaining to systems specifications, lessons learned, analyses from similar systems, common sense, and preliminary design activities. The analyst ties the identified hazards to functions in the system (e.g., inadvertent rocket motor ignition to the ARM and FIRE functions in the system software). The analyst flags these functions and their associated design requirements as safety-critical and enters them into the Requirements Traceability Matrix (RTM) within the Safety Assessment Report (SAR) or Safety Case. The analyst should develop or ensure that the system documentation contains appropriate safety requirements for these safety-critical functions (e.g., ensure that all safety interlocks are satisfied prior to issuing the ARM command or the FIRE command). Lower levels of the specification will include specific safety interlock requirements satisfying these preliminary Safety-Critical Requirements (SCRs). These types of requirements are safety design requirements.

At this point, tradeoffs evolve. It should become apparent at this time whether hardware, software, or human training best mitigates the first-level causal factors of the PHL item (the root event that is undesirable). This causal factor analysis provides insight into the best functional allocation within software design architecture. It should be noted that requirements designed to mitigate the hazard causal factors do not have to be one-to-one, i.e., one software causal factor does not yield one software control requirement. Safety requirements can be one-to-one, one-to-many, or many-to-one in terms of controlling hazard causal factors to acceptable levels of safety risk. In many instances, designers can use software to compensate for hardware design deficiencies or where hardware alternatives are impractical. As software is considered to be cheaper to change than hardware, software design requirements may be designed to control specific hardware causal factors. In other instances, one design requirement (hardware or software) may eliminate or control numerous hazard causal factors (e.g., some generic common global requirements). This is extremely important to understand as it illuminates the importance of not accomplishing hardware safety analysis and software safety analysis separately. A system-level or subsystem-level hazard can be caused by a single causal factor or a combination of many causal factors. The safety analyst must consider all aspects of what causes the hazard and what will be required to eliminate or control the hazard. Hardware, software, and human factors/human system integration can usually not be segregated from the hazard and cannot be analyzed separately. The analysis performed at this level is integrated into the trade-off studies to allow programmatic and technical risks associated with various system architectures to be determined.

Even if a benign module can in any way affect a safety-critical module, it becomes safety-critical via the interface. We don't want to consider everything safety critical, only those, that if missing, erroneous, or ambiguous can fall on the path that can potentially lead to a hazard that can potentially lead to a mishap.

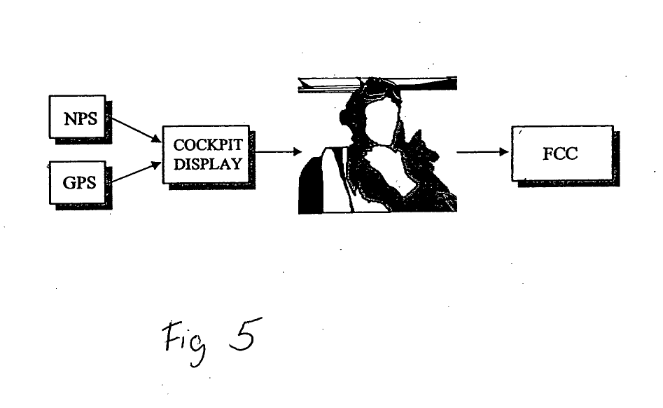

FIG. 5 exemplifies that Navigational Position System (NPS) and Global Positioning System (GPS) information is used in the mission computer algorithm that displays the position of the air vehicle.

It is better not to analyze a mishap after it has occurred (i.e., depend on feedback), but to be proactive (feed forward) and analyze what could happen before it does, so mishaps can be mitigated or even avoided all together. Any component on the path, the flight control computer, the human, the mission computer, the NPS, the GPS, or even the altimeter sensor feeding into the GPS could have contributed to the airplane hitting the mountain. If a portion of an apparently benign component affects the loss of life, property, or environment, it inherits the critically (Hazard Risk Index) of the potential hazard. This includes COTS, GOTS, Non-Developmental Item (NDI), and reuse, as well as original development. Safety-critical interactions may not be obvious and will require in-depth interface analysis of the system design.

During the PHA activities, Step 7a, “Link Causal Factors to Mitigating Safety-Critical Requirements, Functions, Procedures”, of FIG. 2, the linking of the software casual factors to the system-level requirements must be initially established. If there are causal factors that, when inverted descriptively, cannot be linked to a requirement, they must be reported back to the System Safety Working Group (SSWG) for additional consideration as well as development and incorporation of additional requirements or implementations into the system-level specifications.

At this point in time, the manual analysis described herein has proven effective in uncovering many missing specifications on many systems. If a causal factor cannot be linked to a mitigating safety-critical requirement, a new requirement must be specified for the system. This assumes the software developers will meet the requirement. A future goal is to automate this analysis, partially at first via an expert system.

Communication with the software design team is paramount to ensure adequate coverage in preliminary design, detailed design, and testing. The hazards are formally documented in a hazard tracking database record system. They include information regarding the description of the hazard, casual factors, the effects of the hazard (possible mishaps) and the preliminary design considerations for hazard mitigation. These design considerations, along with the Common Global SCRS, represent the preliminary SCRs of the system, subsystems, and their interfaces (if known). These preliminary SCRs must be accurately defined in the hazard-tracking database for extraction when reporting the requirements to the design engineering team. During the early design phases, the safety analyst identifies these requirements to design engineering for consideration and inclusion. This linking is the beginning of the identification of the functionally derived SCRS.

There are two benefits to identifying the safety-critical functions of a system as early as possible. First, the identification assists the SSWG in the categorization and prioritization of safety requirements for the software architecture early in the design life cycle. If the software performs or influences the safety-critical function(s), that module of code becomes safety-critical. This eliminates emotional discussions on whether individual modules of code are designed and tested to specific and extensive criteria. Second, it reduces the level of activity and resource allocations to software code not identified as safety-critical. This benefit is cost avoidance.

The PHA becomes the springboard documentation to launch the SSHA and SHA analyses as the design matures and progresses through the development life cycle. Preliminary hazards can be eliminated (or officially closed through the SSWG) if they are deemed to be inappropriate for the design. Remember that this analysis is preliminary and is used to provide early design considerations that may or may not be derived or matured into design requirements.

From here on the analysis matures and iterates appropriately as more information is available through the next phases of the system safety analysis depicted in MIL-STD-882 and its associated documented evidence.

As the system and subsystem designs mature, the requirements unique to each subsystem also mature via the SSHA. The safety engineer, during this phase of the program, attends design reviews and meetings with the subsystem designers to accurately define the subsystem hazards. The safety engineer documents the identified hazards in the hazard-tracking database and identifies and analyzes the hazard “causes.” When using fault trees as the functional hazard analysis methodology, the causal factors leading to the root hazard determine the derived safety-critical functional requirements. It is at this point in the design that preliminary design considerations are either formalized and defined into specific requirements, or eliminated if they no longer apply with the current design concepts. The SCRs mature, through analysis of the design architecture to connect the root hazard to the causal factors. The analyst continues analysis of the causal factors analysis to the lowest level necessary for ease of mitigation.

This categorization of causes assists in the separation and derivation of specific design requirements that are attributed to software. Both software-initiated causes, and human error causes influenced by software input must be adequately communicated to the systems engineers and software engineers for the purpose of the identification of software design requirements to preclude the initiation of the root hazard identified in the analysis .The PHA document itself is a living document that must be revised and updated as the system design and development progresses. It becomes the input document and information for all other hazard analyses performed on the system. This includes the SSHA, SHA, Health Hazard Assessment (HHA), and Operation & Support Hazard Analysis (O&SHA).

During the development of the SRS, the SSS Team initiates the SSHA and its evaluation of the preliminary software design. This preliminary design analysis assesses the system and software architecture, and provides design recommendations to reduce the associated risk. This analysis provides the basis for input to the design of the Computer Software Configuration Items (CSCIs), and the individual software modules. At this point the software safety engineer must establish a software analysis folder (SAF) for each CSCI or Computer Software Unit (CSU), depending on the complexity of the design to document the analysis results generated. As the design progresses and detailed specifications are available, the SSS Team initiates a SSHA that assesses the detailed software design. The team analyzes the design of each module containing safety-critical functions and the software architecture in the context of hazard failure pathways and documents the results in the SAF. For highly safety-critical software, the analysis will extend to the source code to ensure that the intent of the software safety requirements (SSRs) is properly implemented.

As the system and subsystem designs mature, the requirements unique to each subsystem also mature via the SSHA. The safety engineer, during this phase of the program, attends design reviews and meetings with the subsystem designers to accurately define the subsystem hazards. The safety engineer documents the identified hazards in the hazard-tracking database and identifies and analyzes the hazard “causes.” When using fault trees as the functional hazard analysis methodology, the causal factors leading to the root hazard determine the derived safety-critical functional requirements. It is at this point in the design that preliminary design considerations are either formalized and defined into specific requirements, or eliminated if they no longer apply with the current design concepts. The SSRs mature through analysis of the design architecture to connect the root hazard to the causal factors. The analyst continues the causal factors' analysis to the lowest level necessary for ease of mitigation.

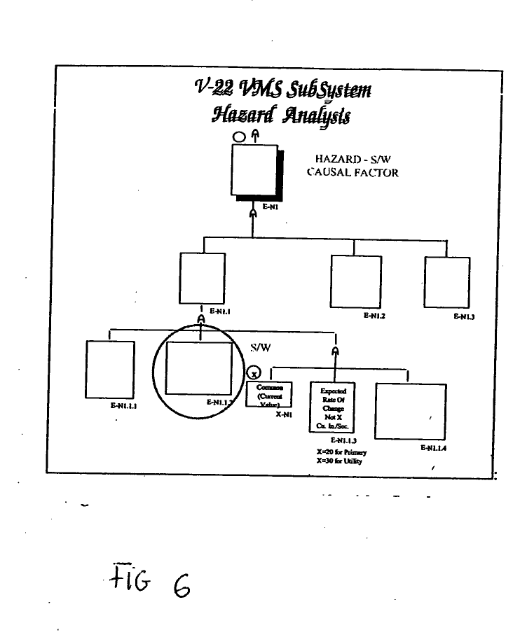

The PHA phase of the program should define causes to at least the CSCI level, whereas the SSHA and SHA should analyze the causes to the algorithm level for areas designated as safety-critical as shown in FIG. 6.

As previously stated, the SSHA is a more in-depth analysis than the PHA. This analysis begins to provide the evidence of requirement implementation by matching hazard causal factors to “what is” in the design to prove or disprove hazard mitigation.

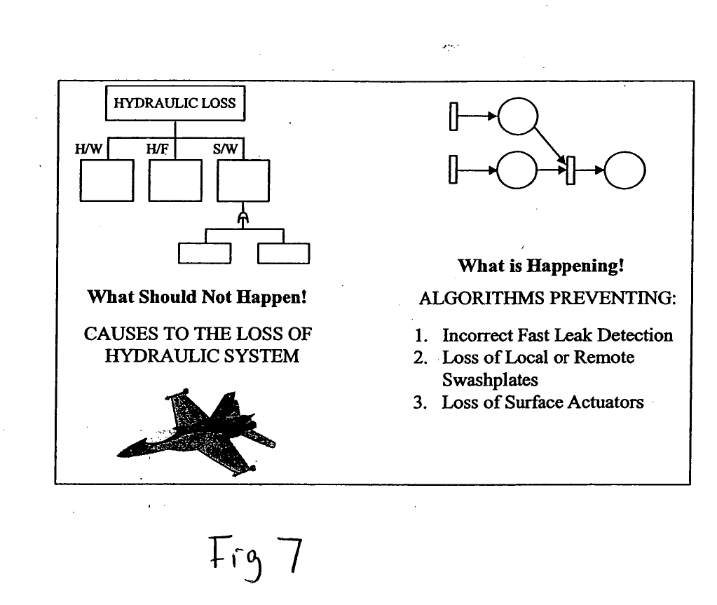

FIG. 7 depicts the linkage of the causal factors (What should not happen!) to the model of the system, (What is happening!) to determine if there are safety-critical mitigating requirements in place or there is still residual risk that needs to be mitigated or accepted.

The information that must be recorded in the SSHA include, but is not limited to, hazard description, all hazard causes (hardware, software, human error, or software-influenced human error), hazard effect, and derived requirements to either eliminate or risk-reduce the hazard by mitigating each causal factor. The inverse of a hazard cause can usually result in a derived requirement. The analysis should also define preliminary requirements for safety warning or control systems, protective equipment, and procedures and training. Also of importance in the data record is the documentation of design phase of the program, component(s) affected, component identification per drawing number, initial Hazard Risk Index (HRI) (which includes probability and severity prior to implementation of design requirements), and the record status (opened, closed, monitored, deferred, etc.).

From a software safety perspective, the SSHA must define those hazards or failure modes that are specifically caused by erroneous, incomplete or missing specifications (including control software algorithm elements, interface inputs and outputs, and threshold numbers), software inputs, or human error (influenced by software furnished information). These records must furnish the basis for the derivation and identification of software requirements that eliminate or minimize the safety risk associated with the hazard. It also must initiate resolution of how the system, or subsystem, will react given the software error does occur. Fault resolution scenarios must consider the reaction of the subsystem and/or system if a potential software error (failure mode) becomes a reality. For example, if a potential error occurs does the system power down, detect the error and correct it, go to a lesser operational state, fail soft, fail safe, fail operational, fail catastrophic, or some combination of these.

The hazard analysis performed on individual subsystems of the (total) system is the SSHA. This analysis is “launched” from the individual hazard records of the PHA, which were identified as a logically distinct portion of a subsystem. Although, the PHA is the starting point of the SSHA, it must be only that—a starting point. The SSHA is a more in-depth analysis of the functional relationships between components and equipment (this also includes the software) of the subsystem. Areas of consideration in the analysis include performance, performance degradation, functional failures, timing errors, design errors, or inadvertent functioning.

The SHA is accomplished in much the same way as the SSHA. That is, hazards and hazard causal factors are identified; hazard mitigation requirements communicated to the design engineers for implementation; and the implementation of the SCRs are verified. However, several differences between the SSHA and SHA are evident. First, the SHA is accomplished during the acquisition life cycle where the hardware and software design architecture matures. Second, where the SSHA focused on subsystem-level hazards, the SHA refocuses on system-level hazards that were initially identified by the PHA. In most instances, the SHA activity will identify additional hazards and hazardous conditions, because the analyst is assessing a more mature design than that which was assessed during the PHA activity. And third, the SHA activity will put primary emphasis on the physical and functional interfaces between subsystems, operational scenarios, and human interfaces.

Due to the rapid maturation of system design, the analysis performed at this time must be in-depth and as timely as possible for the incorporation of any SCRs derived to eliminate or control the system-level hazards. As with the PHA and the SSHA, the SHA must consider all possible causes of these hazards. This includes hardware causes, software causes, human error causes, and software-influenced human error causes. The activity of analyzing hazard causal factors to the level, or depth, necessary to derive mitigation requirements will aid in the identification of physical, functional, and zonal interfaces.

In-depth causal factor analysis during the SHA activities will provide a springboard into the functional interface analysis required at this phase of the acquisition life cycle. In addition, the physical and zonal (if appropriate) interfaces must be addressed. Within the software safety activities, this deals primarily with the computer hardware, data busses, memory, and data throughput. The safety analyst must ensure that the hardware and software design architecture is in compliance with the criteria set by the design specification. In addition, the SHA activities must also formally document the results of the interface hazard analysis.

The SHA provides documentary evidence of safety analyses of the subsystem interfaces and system functional, physical, and zonal requirements. As the SSHA identifies the specific and unique hazards of the subsystem, the SHA identifies those hazards introduced to the system by the interfaces between subsystems, man/machine, and hardware/software. It assesses the entire system as a unit and the hazards and failure modes that could be introduced through system physical integration and system functional integration.

Although interface identification criteria is not required or defined in the SSHA, it is to be hoped that preliminary data is available, and provided by the SSHA analysis format to assist in a “first cut” of the SHA. The SHA is accomplished later in the design life cycle (after Preliminary Design Review (PDR), and before Critical Design Review (CDR)), which increases the cost of design requirements that may be introduced as an output of this analysis. Introducing new requirements this late in the development process also reduces the possibility of completely eliminating the hazard through the implementation of design requirements. It is therefore recommended that initial interface be considered as early as possible in the PHA and SSHA phases of the safety analysis. Having this data in preliminary form allows the maturation of the analysis in the SHA phase of the program to be timelier.

One part of identifying the functional safety-critical requirements is Step 7b, “Identifying Obvious (HW, SW, HF) Safety-Critical Functions/Requirements (out of the available list of requirements) System Requirement Specification (SRS)/Functional Requirement Allocation (FRA) etc.”, of FIG. 2. Some direct examples are engine, flight, and stores control requirements. Indirect examples, that might influence the man-in-the-loop to make an adverse affect on airworthiness, are navigation and Warnings, Cautions, and Alerts (WCAs).

This effort begins with the safety engineer analyzing the functionality of each segment of the conceptual design. From the gross list of system functions, the analyst must determine the safety ramifications of loss of function, interrupted function, incomplete function, function occurring out of sequence, or function occurring inadvertently. This activity also provides for the initial identification of safety-critical functions. The rationale for the identification of safety-critical functions (list) of the system is addressed in the identification of safety deliverables). It should be reiterated at this point, that this is an activity that must be performed as a part of the defined software safety process. This process step ensures that the project manager, systems and design engineers, in addition to the software developers and engineers are aware of each function of the design considered safety-critical or to have a safety impact. It also ensures that each individual module of code that performs these functions is officially labeled as “safety-critical” and that defined levels of design and code analysis and test activity are mandated.

Some safety-critical functions for military aircraft are defined in the United States Naval Air System Flight Clearance Instruction:
Direct Critical Software (Level I): Software and/or firmware:
1. That directly controls the flight dynamics of the aircraft. Examples are flight control computer software and engine control software.
2. That directly controls a flight critical system, provided there is not a backup system that is immediately available if the primary fails. An example is software within the Heads Up Display (HUD) that controls how and where flight critical information is displayed and no backup is available.
3. That provides flight critical data to a flight critical system provided there is not a backup system that is immediately available if the primary fails. Examples are attitude and airspeed data provided by the inertial navigation system and air data computer.
4. That controls the release timing of stores and/or the flight dynamics of stores within the stores separation region. An example is release-timing software within the Stores Management Set.
Indirect Critical Software (Level II):
1. Software and/or firmware that provides critical data to flight critical systems and in-flight management systems which control primary warning or caution systems, fire suppression, stores release systems, essential attitude, and navigation instruments that have. independent backup systems immediately available.
2. Software and/or firmware that provide non-critical data to flight critical systems and in-flight management systems, which control aircrew advisories, stores release systems, and navigation instruments.

Examples of indirect critical software and/or firmware include: (i) FA-18 Mission Computer, Stores Management Set, and Cockpit Display Software that is not flight critical (e.g. fuel displays or engine instruments that have an independent backup); (ii) Inertial Navigation Systems that have independent backup attitude systems immediately available; (iii) environmental control systems.

Some safety-critical requirements can be easily tagged, but others may not be so obvious and are only identified and uncovered via hazard analysis, including causal factor identification and mitigation as supported in MIL-STD-882. The methodology described in this thesis proves to provide visual, traceable evidence that hazards cannot be reached, or that the residual risk is identified.

Step 7c, “Identify Generic Common Global (HW, SW, HF) Safety-Critical Requirements”, from FIG. 2 is executed in parallel with Steps 7aand 7b.

Generic Common Global Safety-Critical Requirements (SCRs) are those design features, design constraints, development processes, “best practices,” coding standards and techniques, and other general requirements that are levied on a system containing safety-critical software, regardless of the functionality of the application. The requirements themselves are not safety specific (i.e., not tied to a specific system hazard). In fact, they may just as easily be identified as reliability requirements, good coding practices, and the like. They are, however, based on lessons learned from previous systems where failures or errors occurred that either resulted in a mishap or a potential mishap. The PHL, as described above, may help determine the disposition or applicability of many individual generic common global requirements. The software safety analysis must identify the applicable common global SCRs necessary to support the development of the SRS as well as programmatic documents (e.g., SDP). A tailored list of these requirements should be provided to the software developer for inclusion into the SRS and other documents.

Several individuals, agencies, and institutions have published lists of generic safety requirements for consideration. To date, the most thorough is included in Appendix B, Generic Safety-Critical Requirement Implementation Guide, which includes the STANAG 4404, NATO Standardization Agreement, Safety Design Requirements and Guidelines for Munitions Related Safety-Critical Computing Systems.

These requirements should be assessed and prioritized according to the applicability to the development effort. Whatever list is used, the analyst must assess each item individually for compliance, noncompliance, or non-applicability. On a particular program, the agreed upon generic SCRs should be included in the Safety Assessment or Safety Case and appropriate high-level system specifications.

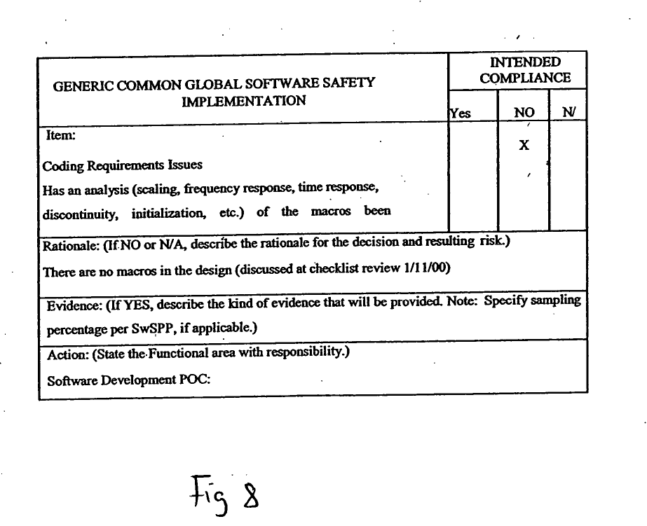

FIG. 8 shows a table that is an example of a worksheet form that may be used to track generic SSR implementation. Whether the program is complying with the requirement, the physical location of the requirement and the physical location of the evidence of implementation must be cited in the EVIDENCE block. If the program is not complying with the requirement (e.g., too late in the development to impose a safety kernel) or the requirement is not applicable (e.g., an Ada requirement when developing in assembly language), a statement of explanation must be included in the RATIONALE block. An alternative mitigation of the source risk that the requirement addresses should be described if applicable, possibly pointing to another generic requirement on the list.

A caution regarding the “blanket” approach of establishing the entire list of guidelines or requirements for a program: Each requirement will cost the program critical resources; people to assess and implement; budget for the design, code, and testing activities; and program schedule. Unnecessary requirements will impact these factors and result in a more costly product with little or no benefit. Thus, these requirements should be assessed and prioritized according to the applicability to the development effort. Inappropriate requirements, which have not been adequately assessed, are unacceptable. The analyst must assess each requirement individually and introduce only those that may apply to the development program.

Some requirements only necessitate a sampling of evidence to provide implementation (e.g., no conditional GO-TO statements). The lead software developer will often be the appropriate individual to gather the implementation evidence of the common global SCRs from those who can provide the evidence. The lead software developer may assign SQA, CM, V&V, human factors, software designers, or systems designers to fill out individual worksheets. The System Safety Working Group should approve the entire tailored list of completed forms.

Step 8, “Trace ALL Safety-Critical Requirements/Functions/Procedures to Compliance/Test. Applying Appropriate Level of Rigour”, of FIG. 2, must be also executed iteratively during each pass of the process. Although this tree diagram can represent the entire system, software safety is particularly concerned with the software causal factors linked to individual hazards in addition to ensuring that the mitigation of each causal factor is traced from requirements to design and code, and subsequently test.

The program manager must predicate the software safety program on the goals and objectives of the system safety and the software development disciplines of the proposed program. The safety program must focus on the identification and tracking (from design, code, and test) of both initial safety-critical requirements, and those requirements derived from system-specific, functional hazards analyses. The software development community has a tendency to focus on only the initial safety-critical requirements while the system safety community may focus primarily on the functional safety-critical requirements derived through hazard analyses. A sound software system safety, as a subset to the system safety program, traces both sets of requirements through test and requirements verification activities. The ability to identify (in total) all applicable safety-critical requirements is essential for any given program and must be adequately addressed.

The team must identify both the common global safety-critical requirements and guidelines and the functional safety design requirements derived from system hazards and failure modes that have specific software input or influence. Once these hazards and failure modes are identified, the team can identify specific safety design requirements through an integrated effort. All safety-critical requirements must be traceable to test and be correct, complete, and testable where possible. The RTM within the safety assessment report documents this traceability. The implemented requirements must eliminate, control, or reduce the safety risk as low as reasonably possible while meeting the user requirements within operational constraints.

The analyst develops and analyzes the RTM to identify where the safety-critical requirements are implemented in the code, safety-critical requirements that are not being implemented, and code that does not fulfill the intent of the safety-critical requirements. The traced safety-critical requirements should not just be those identified by the top-level specifications, but those safety-critical requirements identified by the SRS, Software Design Document (SDD), and Interface Control Document (ICD)/Interface Design Specification (IDS).

Tracing encompasses two distinct activities: a requirement-to-code trace and a code-to-requirement trace. The forward trace, requirement-to-code, first identifies the requirements that belong to the functional area (if they are not already identified through requirement analysis). The forward trace then locates the code implementation for each requirement. A requirement may be implemented in more than one place thus making the matrix format very useful.

It is during the traceability stage, after the safety-critical requirements have been identified, that the appropriate level of rigour is applied to provide evidence in the safety assessment report or safety case. An example is the use of the control categories in MIL-STD-882.

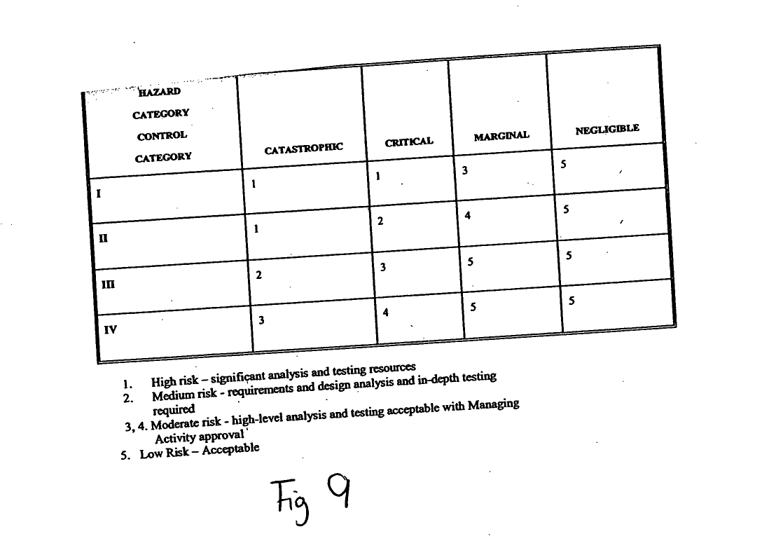

The degree of control is defined using the software control categories. The Software Control Categories include:
I. software exercises autonomous control over potentially hazardous hardware systems, subsystems or components without the possibility of intervention to preclude the occurrence of a hazard. Failure of the software or a failure to prevent an event leads directly to a hazard's occurrence.
IIa Software exercises control over potentially hazardous hardware systems, subsystems, or components allowing time for intervention by independent safety systems to mitigate the hazard. However, these systems by themselves are not considered adequate.
II.b. Software item displays information requiring immediate operator action to mitigate a hazard. Software failures will allow or fail to prevent the hazard's occurrence.
III.a. Software item issues commands over potentially hazardous hardware systems, subsystems or components requiring human action to complete the control function. There are several, redundant, independent safety measures for each hazardous event.
III.b. Software generates information of a safety critical nature used to make safety critical decisions. There are several, redundant, independent safety measures for each hazardous event.
IV. Software does not control safety critical hardware systems, subsystems or components and does not provide safety critical information.
   a. Software Hazard Critically Matrix. The Software Hazard Critically Matrix (FIG. 9) is similar to the Hazard Risk Assessment Matrix. The matrix is established using the hazard categories for the rows and the Software Control Categories for the columns. The matrix is completed by assigning Software Hazard Risk Index numbers to each element just as Hazard Risk Index numbers are assigned in the Hazard Risk Assessment Matrix. A Software Hazard Risk Index (SHRI) of ‘1’ from the matrix implies that the risk may be unacceptable. A SHRI of ‘2’ to ‘4’ is undesirable or requires acceptance from the managing activity. Unlike the hardware related HRI, a low index number does not mean that a design is unacceptable. Rather, it indicates that greater resources need to be applied to the analysis and testing of the software and its interaction with the system.”[MUL-STD Systems Safety].

The backward trace, code-to-requirement, is performed by identifying the code that does not support a requirement or a necessary “housekeeping” finction. In other words, the code is extraneous (e.g., “debugging” code left over from the software development process). The safety analyst performs this trace through an audit of the applicable code after he or she has a good understanding of the corresponding requirements and system processing. Code that is not traceable should be documented and eliminated if practical.

Step 9, “Report Safety Assessment”, of FIG. 2, must be executed at the appropriate milestone event, such as a design review, flight clearance, or acceptance board event.

The PHA and subsequent SSHA and SHA activities are the safety engineering and software safety engineering functions that are performed to identify the hazards and their preliminary casual factors of the system in development. The hazards are formally documented to include information regarding the description of the hazard, casual factors, the effects of the hazard, and preliminary design considerations for hazard control by mitigating each cause. Performing the analysis includes assessing hazardous components, safety-related interfaces between subsystems, environmental constraints, operation, test and support activities, emergency procedures, test and support facilities, and safety-related equipment and safeguards.

The safety assessment report houses all of the evidence that the hardware, software, and human factors/human system integration cannot contribute to the loss of life, property, and environment in any operational environment. This would include specifically, in the case of software, any FMECAs, functional hazard analyses, common global hazard analyses, traceability to implementation/test, and any residual risk that will not be mitigated. Essentially the safety assessment

What is claimed is:

1. A method for reducing hazards in a system under development, the method comprising:
determining a hazard of the system under development;
determining causal factors of the hazard;
determining mitigating requirements of the hazard;
linking the causal factors to the mitigating requirements; and
choosing an optimal mitigating requirement.

2. A method for reducing hazards in a system under development, the method comprising:
determining hazards of the system under development;
developing a primary hazard list from the hazards;
determining causal factors of the hazards listed in the primary hazard list;
determining mitigating requirements of the hazards listed in the primary hazard list;
linking the causal factors to the mitigating requirements; and
choosing an optimal mitigating requirement.

3. The method of claim 2, wherein when choosing the optimal mitigating requirement, multiple mitigating requirements are chosen such that a user's belief in any of the hazards is below a predetermined value.

4. The method of claim 2, wherein the primary hazard list is the initial set of hazards associated with the system under development and is based on review of analysis of similar systems, lessons learned, potential kinetic energies associated with design, design handbooks, and user and systems specifications.

5. The method of claim 4, wherein the list of preliminary hazards of the proposed system becomes the basis of a Preliminary Hazard Analysis (PHA) and the consideration and development of design alternatives including eliminating those hazards that are not applicable for the proposed system.

6. The method of claim 2, wherein the causal factors are tied to specific software and safety critical functions which are functionally linked to the primary software design architecture.

7. The method of claim 6, wherein the PHA is a safety engineering and software safety engineering analysis offering alternative considerations performance, reproducibility, testability, survivability, compatibility, supportability, reliability, and system safety during each phase of the development life cycle.

8. The method of claim 7, wherein the hazards are categorized and prioritized according to a predetermined Hazard Risk Index.
